(19) United States
(12) Patent Application Publication
(10) Pub. No.: US 2026/0211799 A1
(43) Pub. Date: Jul. 23, 2026

(54) MANAGING CODE TESTING PROCESSES BASED ON CHANGE MAGNITUDES

(71) Applicant: Dell Products L.P., Round Rock, TX (US)

(72) Inventors: BORIS SHPILYUCK, Ashdod (IL); YONIT LOPATINSKI, Shomria (IL); OR HERMAN SAFFAR, Ofakim (IL); JEHUDA SHEMER, Kfar Saba (IL)

(21) Appl. No.: 19/033,039

(22) Filed: Jan. 21, 2025

(51) Int. Cl. G06F 11/3668; G06F 8/65; G06F 11/3604

(52) U.S. Cl. CPC G06F 11/3676; G06F 8/65; G06F 11/3604

(57) ABSTRACT

Methods and systems for providing computer-implemented services using a data processing system are disclosed. To provide the computer-implemented services, a code testing process for a set of changes for a codebase may be obtained. Using the set of changes, an analysis process may be performed to obtain a change magnitude for the set of changes. Based on the change magnitude, a level of coverage threshold may be obtained for a code testing process for the set of changes. The code testing process may be performed, and a level of coverage achieved during the code testing process may be obtained. If the level of coverage meets the level of coverage threshold, the set of changes may be integrated into the codebase to obtain an updated codebase and the software based on the integrated codebase may be deployed to facilitate provisioning of desired computer-implemented services.

### FIELD

Embodiments disclosed herein relate generally to managing source code changes. More particularly, embodiments disclosed herein relate to systems and methods to manage testing processes for source code changes based on change magnitudes.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2C show diagrams illustrating data flows in accordance with an embodiment.

FIGS. 3A-3C show flow diagrams illustrating a method for providing computer-implemented services in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using a data processing system. To provide the computer-implemented services to the downstream consumer, the data processing system may include any number of hardware components, such as processors, memory modules, storage devices, communication devices, etc. The hardware components of the data processing system may support execution of any number and/or type of software components (e.g., software programs). Changes in available functionalities of the hardware components and/or the software components of the data processing system may provide for various types of different computer-implemented services to be provided to the downstream consumer.

Over time, the software components of the data processing system may be modified. For example, a software program hosted by the data processing system may be updated to improve performance of the data processing system, add functionality to the data processing system, reduce a security risk associated with the software program, etc. Updates and/or other modifications made to the software components of the data processing system may allow for additional computer-implemented services to be provided, more reliable computer-implemented services to be provided, the computer-implemented services to be provided in a more secure manner, and/or other improvements to the computer-implemented services provided to the downstream consumer.

The software components of the data processing system may be modified by integrating a set of changes to source code for a software program (e.g., software) into a codebase. However, integrating the set of changes into the codebase may have undesired impacts on the software program. For example, the changes may introduce bugs and/or errors into the software program, reduce maintainability of the software program, introduce compatibility and/or performance issues, introduce security issues (e.g., introduce new security vulnerabilities and/or expose existing security vulnerabilities), and/or result in other undesired impacts on the software program. Consequently, the computer-implemented services provided to the downstream consumer using the software program may be delayed, provided in a manner that does not meet the expectations of the downstream consumer, and/or may otherwise be negatively impacted.

To reduce a likelihood of errors being introduced to the codebase and/or other undesired impacts on the functionality of the software program, the set of changes may be analyzed prior to integrating the set of changes into the codebase to obtain a change magnitude for the set of changes. The change magnitude may indicate a level of change to the source code should the set of changes be integrated into the codebase.

Obtaining the change magnitude for the set of changes may include obtaining a criticality value and a similarity value for the set of changes. The criticality value may indicate a degree of impact of integrating the set of changes into the codebase (e.g., based on a number of application programming interfaces (APIs) of an API call chain impacted by the set of changes). The similarity value may indicate a degree of similarity between the source code before and the source code after the integration of the set of changes into the codebase (e.g., based on changes in functionality of the software program and/or other similarity metrics). The change magnitude may be calculated as a weighted sum of the criticality value and the similarity value for the set of changes. Based on the change magnitude, at least one action may be identified to manage integration of the set of changes into the codebase (e.g., based on a policy for integrating sets of changes).

Prior to integrating the set of changes into the codebase for a portion of the software, a code testing process may be performed to determine whether the software updated based on the integrated codebase operates in an acceptable manner. For example, the code testing process may include testing at least a portion of the functionalities of the software updated based on the integrated codebase. A code testing result and a level of coverage achieved during the code testing process may be obtained as a result of the code testing process. The code testing result may indicate whether the software updated based on the integrated codebase performed in an acceptable manner and the level of coverage may indicate a level of testing of functionalities of the software during the code testing process.

A level of coverage threshold may be obtained for the code testing process based on the change magnitude. For example, the level of coverage threshold may be obtained using a process keyed to the change magnitude (e.g., the level of coverage threshold may increase as the change magnitude increases).

The level of coverage achieved during the code testing process may be compared to the level of coverage threshold. If the level of coverage meets the level of coverage threshold, the set of changes may be integrated into the codebase and an updated codebase may be obtained. The updated codebase may be integrated into the software and the software updated based on the updated codebase may be deployed to facilitate provisioning of desired computer-implemented services.

If the level of coverage does not meet the level of coverage threshold, the set of changes may be rejected for integration into the codebase.

Thus, embodiments disclosed herein may address, among other technical problems, the technical challenge of integrating sets of changes into codebases. By managing integration of a set of changes into a codebase for a software program using a change magnitude for the set of changes and a level of coverage threshold, a likelihood of errors being introduced into the codebase and/or other undesired impacts on the functionality of the software program may be reduced. Consequently, a likelihood of providing the computer-implemented services using the software program in a manner that meets the expectations of a downstream consumer of the computer-implemented services may be improved.

In an embodiment, a method for providing computer-implemented services using a data processing system is disclosed. The method may include: making an identification that a code testing process is to be performed for a set of changes for a codebase for a portion of software; based on the identification: obtaining, based on the set of changes, a change magnitude, the change magnitude indicating a level of change to operation of the software should the set of changes be integrated into the codebase and the software updated based on the integrated codebase; obtaining, based on the change magnitude, a level of coverage threshold for the code testing process, the level of coverage threshold indicating a minimum level of testing of functionalities of the software; performing the code testing process on the software updated based on the integrated codebase to obtain a code testing result and a level of coverage achieved during the code testing process, the code testing result indicating whether the software updated based on the integrated codebase operates in an acceptable manner; in a first instance of the code testing process in which the level of coverage meets the level of coverage threshold: integrating of the set of changes into the codebase to obtain an updated codebase; and deploying the software updated based on the updated codebase to facilitate provisioning of desired computer-implemented services.

The method may also include: in a second instance of the code testing process in which the level of coverage does not meet the level of coverage threshold: rejecting the set of changes for integration into the codebase.

The codebase may include source code for the portion of software and the set of changes may include potential changes to at least a portion of the source code usable to obtain an updated version of the software.

The level of coverage threshold may be obtained using a process that is keyed to the change magnitude, and the process may scale the level of coverage threshold with the change magnitude.

The process may use bucketized ranges that associate different change magnitudes with different level of coverage thresholds.

A higher change magnitude may indicate integrating the set of changes into the codebase has an increased risk of undesired impacts on instances of the software obtained from the integrated codebase.

A higher change magnitude may be keyed to a level of coverage threshold associated with more extensive testing requirements than a lower change magnitude.

The level of coverage meeting the level of coverage threshold may indicate integrating the set of changes into the codebase has an acceptable risk of the undesired impacts on the instances of the software obtained from the integrated codebase.

The change magnitude may be a weighted sum of a criticality value and a similarity value.

The criticality value may indicate a degree of impact of integrating the set of changes into the codebase. The degree of impact may be based on a number of application programming interfaces (APIs) impacted by the set of changes.

The similarity value may be based on a difference between a first summary of the set of changes and a second summary of the at least a portion of source code for the portion of software.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

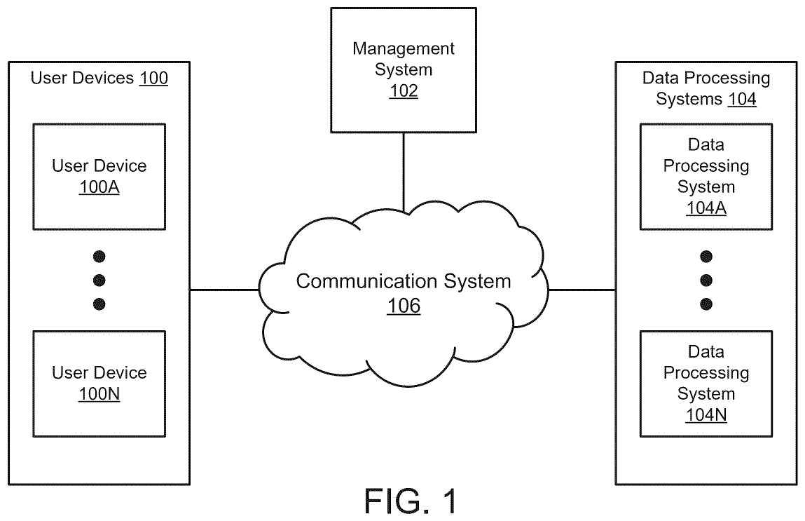

Turning to FIG. 1, a block diagram illustrating a system in accordance with an embodiment is shown. The system shown in FIG. 1 may provide computer-implemented services. The computer implemented services may include any type and quantity of computer-implemented services. For example, the computer-implemented services may include data storage services, instant messaging services, database services, and/or any other type of service that may be implemented with a computing device. Other types of computer-implemented services may be provided by the system without departing from embodiments disclosed herein.

The computer-implemented services may be provided using data processing systems 104 (and/or other devices) to any number of downstream consumers of the computer-implemented services (e.g., users of data processing systems 104 such as businesses and/or individuals). Data processing systems 104 may include any number of hardware components, such as processors, memory modules, storage devices, communication devices, etc. The hardware components of data processing systems 104 may support execution of any number and/or type of software components (e.g., applications and/or other types of software programs). Changes in available functionalities of the hardware components and/or the software components of data processing systems 104 may provide for various types of different computer-implemented services to be provided to the downstream consumers.

Over time, the software components of data processing systems 104 may be modified. For example, portions of the software components may be updated to improve performance of data processing systems 104, add functionality to data processing systems 104, reduce a security risk associated with a portion of the software components, etc. Updates and/or other modifications made to the software components of data processing systems 104 may allow for additional computer-implemented services to be provided, more reliable computer-implemented services to be provided, the computer-implemented services to be provided in a more secure manner, and/or other improvements to the computer-implemented services provided to the downstream consumers.

To modify the software components of data processing systems 104, the system may include any number of user devices 100. User devices 100 may be used by users such as programmers, developers, engineers, and/or other users to generate, update, modify, and/or otherwise manage at least a portion of the software components of data processing systems 104. For example, user devices 100 may be used to modify the software components by integrating changes to source code for a software program (e.g., a portion of the software components) into a codebase for the software program.

However, integrating the changes into the codebase may have undesired impacts on the software program. For example, the changes may introduce bugs and/or errors into the software program, reduce maintainability of the software program, introduce compatibility and/or performance issues, introduce security issues (e.g., introduce new security vulnerabilities and/or expose existing security vulnerabilities), and/or result in other undesired impacts on the software program. Consequently, the computer-implemented services provided to the downstream consumers using the software program may be delayed, provided in a manner that does not meet the expectations of the downstream consumers, and/or may otherwise be negatively impacted.

In general, embodiments disclosed herein may provide methods, systems, and/or devices for integrating changes to source code for a software program into a codebase in a manner that reduces a likelihood of negatively impacting computer-implemented services provided using the software program. To do so, a set of changes for the codebase including potential changes to the source code for the software program may be obtained. The set of changes may be analyzed to obtain a change magnitude for the set of changes indicating a level of change to the source code should the set of changes be integrated into the codebase. Based on the change magnitude, at least one action may be identified to manage integration of the set of changes into the codebase (e.g., based on a policy for integrating sets of changes).

Performing the analysis process for the set of changes to obtain the change magnitude may include obtaining a criticality value and a similarity value for the set of changes. The criticality value may indicate a degree of impact of integrating the set of changes into the codebase. For example, the criticality value may be evaluated based on a number of application programming interfaces (APIs) of an API call chain impacted by the set of changes. The similarity value may indicate a degree of similarity between the source code before and the source code after the integration of the set of changes into the codebase (e.g., based on changes in functionality of the software program and/or other similarity metrics).

Prior to integrating the set of changes into the codebase for at least a portion of the software, a code testing process may be performed. Performing the code testing process may include generating an instance of the integrated codebase and executing at least a portion of the integrated codebase to test functionalities of the software updated based on the integrated codebase.

However, not all functionalities of the updated software may be testing during the code testing process. Testing a higher percentage of the functionalities of the software may reduce a likelihood of undesirable impacts on the software as a result of integrating the set of changes. However, more extensive testing may also consume more resources (e.g., computing resources, time resources). Consequently, a tradeoff may exist between resource consumption and testing coverage.

To determine whether the testing coverage is considered acceptable, a level of coverage threshold may be obtained for the code testing process. The level of coverage threshold may be based on the change magnitude, with the level of testing threshold scaling with the change magnitude (e.g., a higher change magnitude may be keyed to a higher level of coverage threshold than a lower change magnitude).

As a result of the code testing process, a code testing result and a level of coverage achieved during the code testing process may be obtained. The code testing result may indicate whether the portion of the software tested operated in an acceptable manner and the level of coverage may indicate a level of testing of functionalities of the software.

If the level of coverage meets the level of coverage threshold, the code testing process may be considered acceptable. The set of changes may, therefore, be integrated into the codebase to obtain an updated codebase. The updated codebase may be integrated into the software and the software updated based on the updated codebase may be deployed to facilitate provisioning of desired computer-implemented services.

If the level of coverage does not meet the level of coverage threshold, the set of changes may be rejected for integration into the codebase.

By doing so, embodiments disclosed herein may reduce a likelihood of errors being introduced into the codebase and/or other undesired impacts on the functionality of the software program. As a result, a likelihood of providing the computer-implemented services in a manner that meets the expectations of downstream consumers of the computer-implemented services may be improved.

To provide the above noted functionality, the system of FIG. 1 may include user devices 100, management system 102, data processing systems 104, and communication system 106. Each of these components is discussed below.

Data processing systems 104 may include any number and/or type of data processing systems (e.g., 104A-104N). Each data processing system of data processing systems 104 may include hardware and/or software components (e.g., software programs) configured to facilitate the provision of all, or a portion of, the computer-implemented services to downstream consumers of the computer-implemented services (e.g., users of data processing systems 104). The downstream consumers may include, for example, businesses, individuals, and/or other users that may consume computer-implemented services provided using data processing systems 104.

For example, a data processing system (e.g., data processing system 104A) may be used by a hospital (e.g., a downstream consumer) to store patient information. The computer-implemented services provided using data processing system 104A may include secure data storage services, which may be facilitated using a security program (e.g., a software component of data processing system 104A). The security program may be used to encrypt the patient information, regulate access to the patient information, and/or otherwise protect the patient information from being accessed by unauthorized entities.

The software programs may be updated, modified, and/or otherwise maintained using user devices 100. User devices 100 may include any type and/or quantity of user devices (e.g., 100A-100N), which may include data processing systems and/or other computing devices. Users of user devices 100 may have various roles related to maintaining and/or modifying the functionality software programs of data processing systems 104. For example, the user roles may include writing initial source code for the software programs, identifying functionalities (e.g., desired by the downstream consumers) to be added to the software programs, identifying security vulnerabilities of the software programs, obtaining sets of changes for codebases associated with the software programs, and/or performing other tasks.

The sets of changes may be obtained to: (i) address bugs and/or other errors in the source code (e.g., that cause the software programs to operate in unexpected and/or undesired manners), (ii) improve performance of the software programs (e.g., to allow the software programs to run faster, use less memory, and/or consume fewer resources), (iii) address security vulnerabilities, (iv) add the desired functionalities to the software programs, (iv) adapt to changes in underlying environments and/or technologies used by the software programs, and/or (v) otherwise improve and/or maintain the software programs.

Returning to the above example, the security program used to provide the secure data storage services may be updated to improve security of the patient information and/or add functionality to the security program, such as additional authentication procedures to reduce a likelihood of the patient information being accessed by unauthorized users. A set of changes may be generated using user device 100A to update the source code of the codebase for the security program.

User devices 100 may be managed by management system 102. Management system 102 may include any number and/or type of devices (e.g., data processing systems) used to manage codebases and/or tasks performed by user devices 100 related to the codebases. For example, management system 102 may: (i) obtain the sets of changes (e.g., from user devices 100), (ii) perform analysis processes for the sets of changes, (iii) manage integration of the sets of changes into the codebases (e.g., based on policies for managing codebases), (iv) perform tasks related to maintaining the codebases, and/or (v) perform other tasks to facilitate provision of the computer-implemented services using the software programs used by data processing systems 104.

Management system 102 may also oversee code testing processes for sets of changes to a codebase for a portion of software. For example, as part of overseeing a code testing process, management system 102 may: (i) obtain, based on the change magnitude, a level of coverage threshold for the code testing process, (ii) perform the code testing process on the software based on the integrated codebase to obtain a code testing result and a level of coverage achieved during the code testing process, and/or (iii) determine whether the level of coverage meets the level of coverage threshold. If the level of coverage meets the level of coverage threshold, management system 102 may: (i) integrate the set of changes into the codebase to obtain an updated codebase, (ii) deploy the software updated based on the integrated codebase to facilitate provisioning of desired computer-implemented services, and/or (iii) perform other actions.

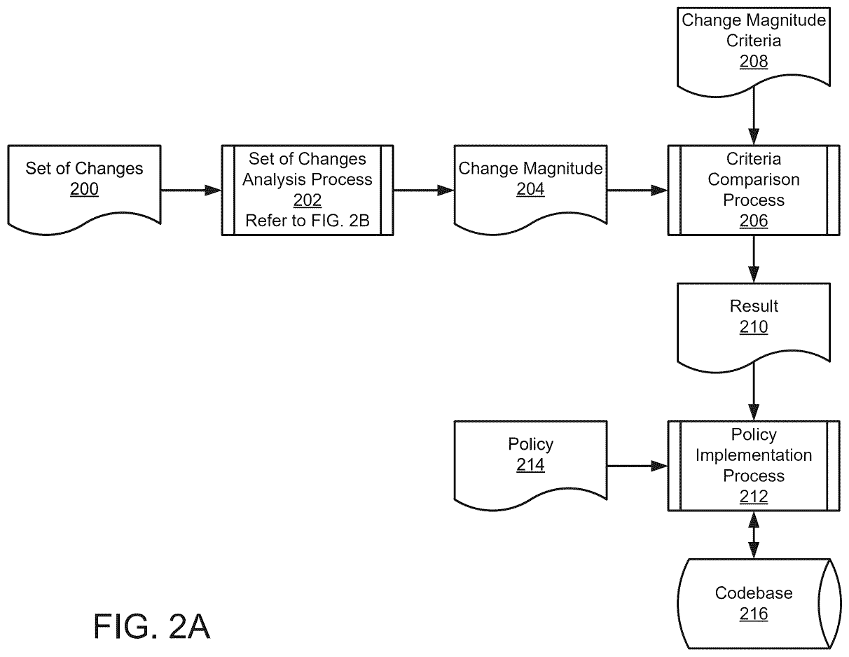

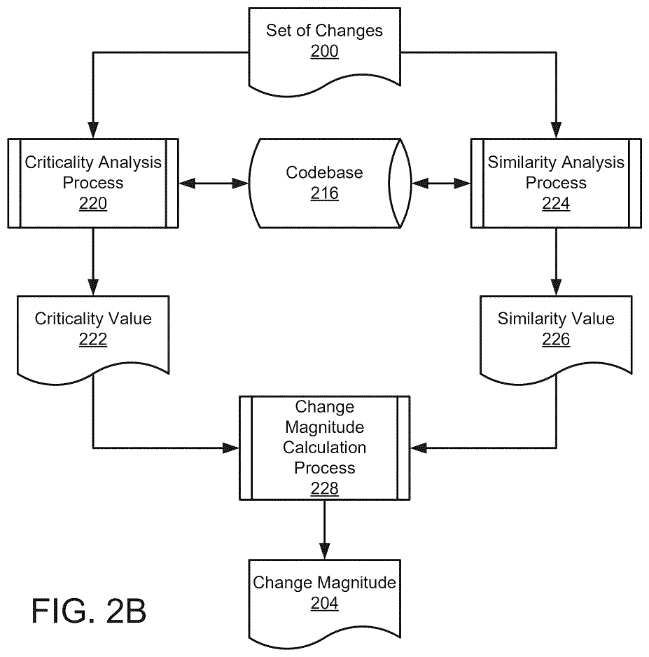

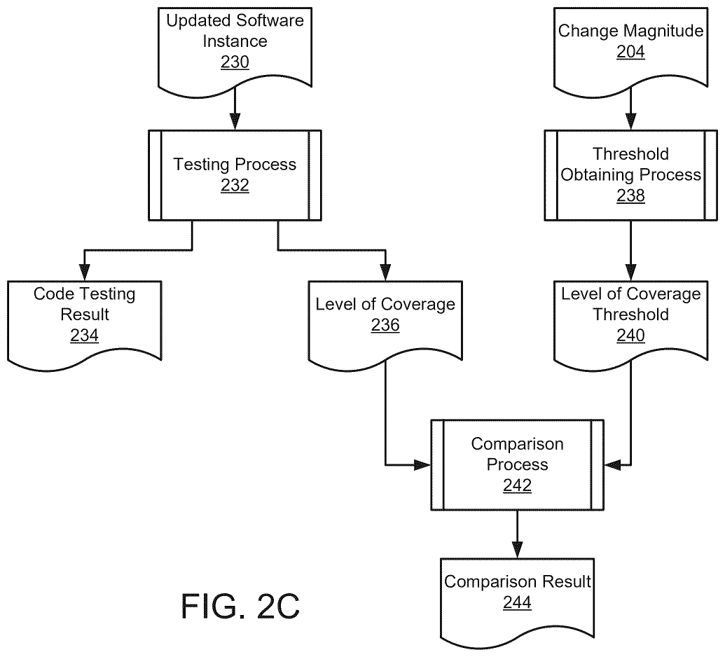

By performing its functionality, management system 102 may reduce a likelihood of undesired impacts on the software programs as a result of integrating sets of changes into the codebases. Refer to the description of FIGS. 2A-2B for additional details regarding analysis of sets of changes and integration of sets of changes into codebases. Refer to FIG. 2C for additional details regarding code testing processes and use of level of coverage thresholds to determine whether to update the codebase using the set of changes.

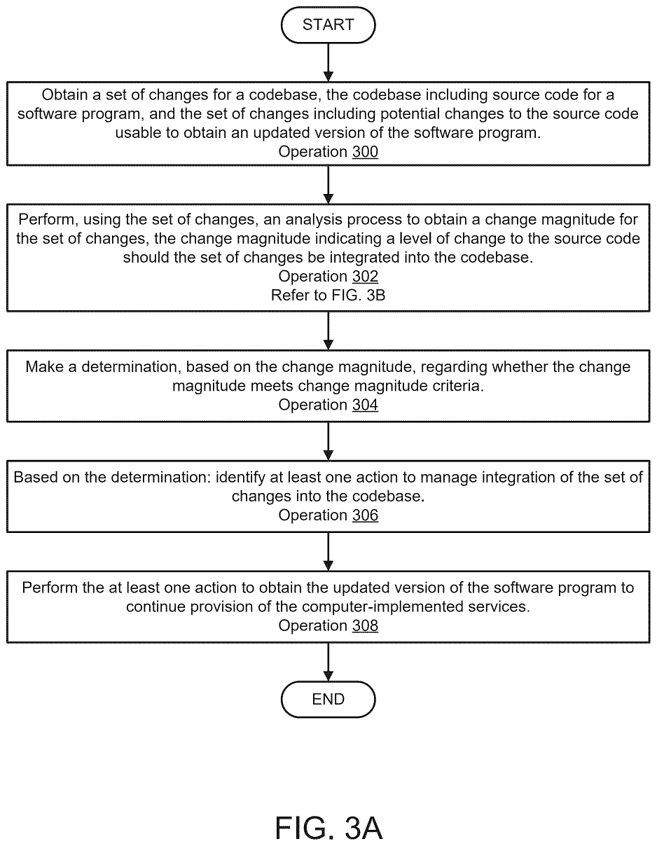

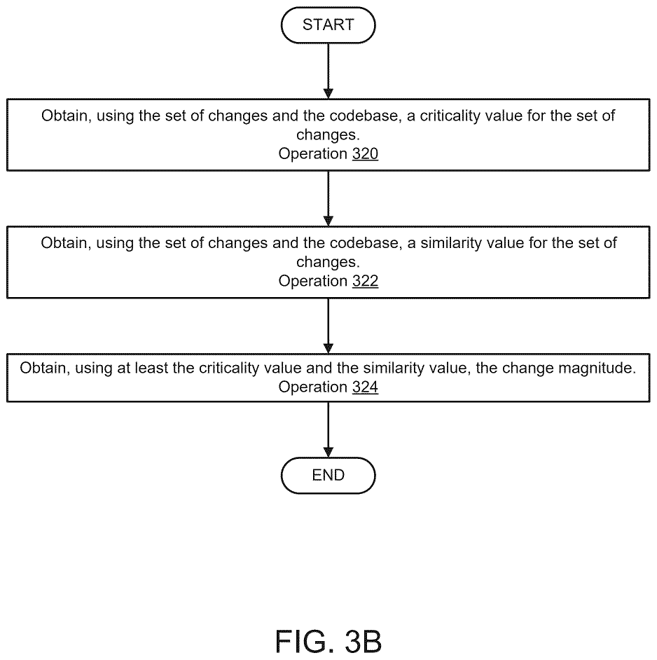

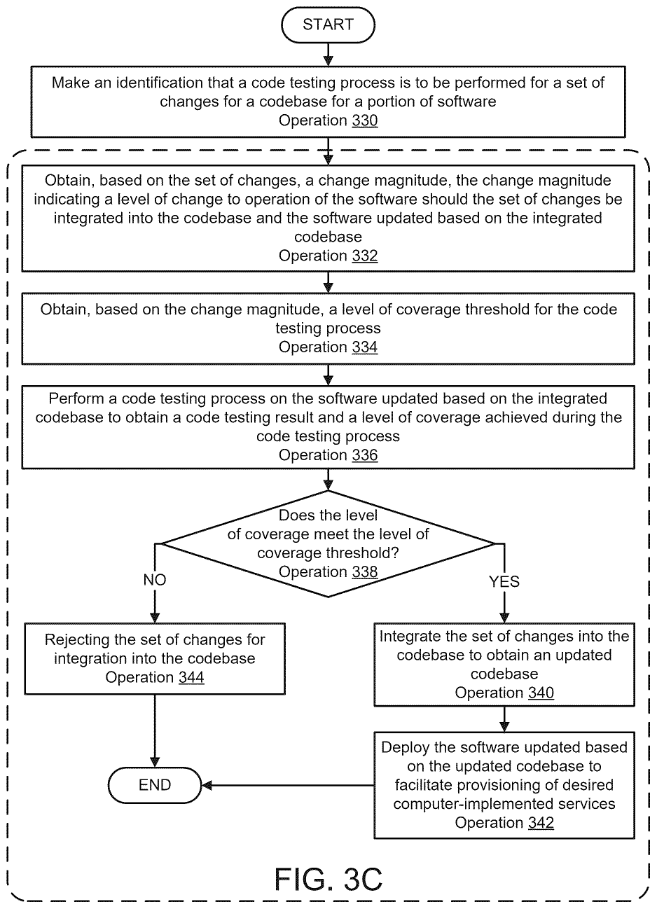

When providing their functionality, any of (and/or components thereof) user devices 100, management system 102, and/or data processing systems 104 may perform all, or a portion, of the actions and methods illustrated in FIGS. 2A-3C.

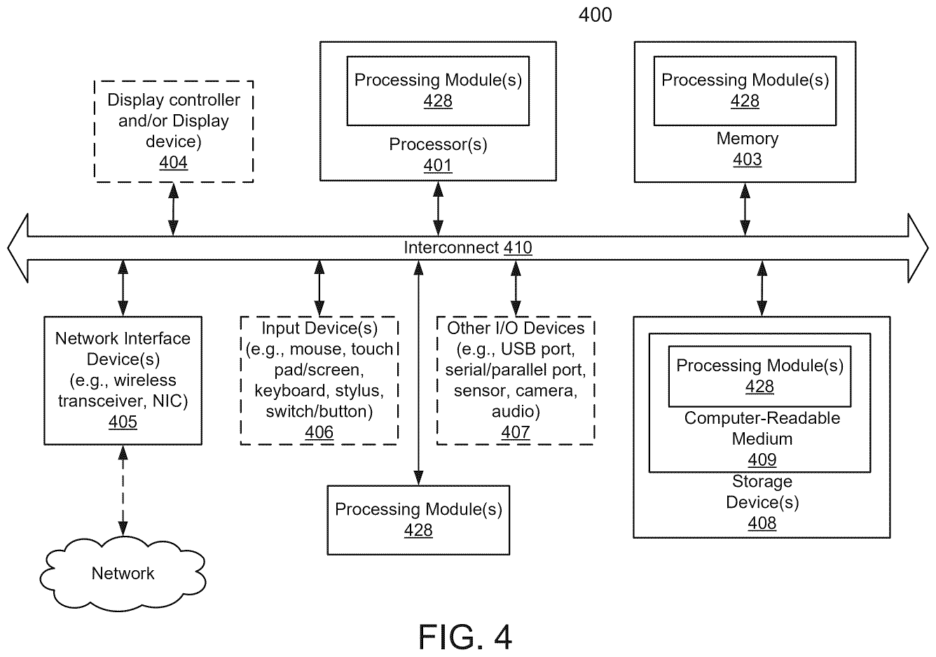

Any of (and/or components thereof) user devices 100, management system 102, and/or data processing systems 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Management system 102 may be implemented with multiple computing devices. The computing devices of management system 102 may cooperatively perform processes for managing codebases. The computing devices of management system 102 may perform similar and/or different functions, and may be used by different persons (e.g., users) that may participate in the management of codebases. For example, management system 102 may include multiple computing devices used by managers, programmers, developers, engineers, and/or other users (e.g., persons) tasked with managing codebases.

Management system 102 may be maintained, for example, by a business or other entity that has some degree of responsibility with respect to managing the operation of user devices 100. For example, management system 102 may be operated by a software company that employs and/or otherwise cooperates with users of user devices 100.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

The system described in FIG. 1 may be used to facilitate provision of computer-implemented services using a data processing system. The following processes described in FIGS. 2A-2C may be performed by the system in FIG. 1 when providing this functionality.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 200, 204, etc.) is used to represent data structures, a second set of shapes (e.g., 202, 206, etc.) is used to represent processes performed using and/or that generate data, and a third set of shapes (e.g., 216) is used to represent large scale data structures such as databases.

Turning to FIG. 2A, a first data flow diagram in accordance with an embodiment is shown. The first data flow diagram may illustrate data used in and data processing performed in managing integration of a set of changes (e.g., set of changes 200) into a codebase for a software program (e.g., codebase 216).

To do so, set of changes 200 may be obtained for codebase 216. Codebase 216 may include source code for a software program, which may include a set of instructions and/or other code (e.g., written by programmers, software developers, and/or other users) for performing actions related to running the software program. Codebase 216 may include source code written in any programming language (e.g., Python, HTML, C++, Java).

Set of changes 200 may include potential changes to at least a portion of the source code included in codebase 216, which may be usable to obtain an updated version of the software program. For example, set of changes 200 may include a set of alterations for the at least the portion of the source code packaged together, and/or metadata regarding the set of alterations (e.g., a description of set of changes 200 provided by a user who wrote set of changes 200, an identifier for the user, a date set of changes 200 was written). Refer to the description of FIG. 1 for additional details regarding sets of changes for codebases.

Set of changes 200 may be used to perform set of changes analysis process 202 to obtain change magnitude 204. Change magnitude 204 may indicate a level of change to the source code should set of changes 200 be integrated into codebase 216. For example, the level of change may include a difference in functionality of the software program before and after integration of set of changes 200 (e.g., rather than a change in size of the source code). For example, obtaining a higher change magnitude 204 (e.g., based on a numerical and/or any other type of scale) may indicate integrating set of changes 200 into codebase 216 has an increased risk of undesired and/or unintended impacts on the updated version of the software program. For additional details regarding performing set of changes analysis process 202 and/or change magnitude 204, refer to the description of FIG. 2B.

For example, a data processing system (e.g., of data processing systems 104 described in FIG. 1) may include an antivirus software program. The antivirus software program may include functionalities for detecting malware on the data processing system. A first set of changes may be obtained for the antivirus software program including minor revisions to the source code intended to enhance readability of a portion of the source code. A change magnitude of 2 (e.g., on a scale of 1-10, where a change magnitude of 10 represents the highest level of change to the source code) may be obtained for the first set of changes. A second set of changes may be obtained for the antivirus software program intended to add functionality of the antivirus software program to remove detected malware from the data processing system. The second set of changes may include revising a larger portion of the source code relative to the first set of changes. As a result, a change magnitude of 8 may be obtained for the second set of changes. Thus, integrating the second set of changes into the codebase may have a higher risk of undesired impacts on the antivirus software program than integrating the first set of changes into the codebase.

Change magnitude 204 may then be used to perform criteria comparison process 206. During criteria comparison processes 206, a determination may be made regarding whether change magnitude 204 meets change magnitude criteria 208 (e.g., by an entity responsible for managing sets of changes for codebases, such as management system 102 described in FIG. 1). Change magnitude criteria 208 may be provided by a downstream consumer (e.g., obtained from any of data processing systems 104), a subject matter expert (SME), and/or any other entity participating in managing the integration of set of changes 200 into codebase 216. Change magnitude criteria 208 may include any number of thresholds, rule sets, and/or other means of determining whether a value of change magnitude 204 indicates set of changes 200 is permitted to be integrated into codebase 216.

For example, change magnitude criteria 208 may include a threshold value for change magnitude 204, and meeting the threshold value may indicate that integrating set of changes 200 into codebase 216 has an unacceptable risk of undesired impacts on the updated version of the software program.

For example, a set of changes for a codebase for a software program may be obtained, and the change magnitude for the set of changes may be calculated to be 85 on a scale of 1-100, where 1 indicates a lowest level of change to the source code, and 100 indicates a highest level of change to the source code. Change magnitude criteria for sets of changes to the software program may be set by a managing entity of the software program, such as a software company that produces the software program. The change magnitude criteria, for example, may indicate a threshold change magnitude of 50 to permit the set of changes to be integrated into the codebase. Therefore, in this example, the change magnitude would exceed the threshold change magnitude for the set of changes to be considered acceptable, and the set of changes would not meet the change magnitude criteria.

While described above with respect to a single quantity and a single corresponding threshold, it will be appreciated that any number of quantities may be compared to any number of corresponding thresholds and/or any other types of rules may be applied to determine whether change magnitude criteria 208 are met without departing from embodiments disclosed herein.

As a result of criteria comparison process 206, result 210 may be obtained. Result 210 may include an indication of whether change magnitude 204 meets change magnitude criteria 208. For example, result 210 may include: (i) a “yes” or “no” answer, (ii) change magnitude 204, (iii) a difference between change magnitude 204 and the threshold value included in change magnitude criteria 208, (iv) any other quantification of the level of change to the source code should set of changes 200 be integrated into codebase 216 based on change magnitude 204, and/or (v) other quantities and/or information.

Based on result 210, policy implementation process 212 may be performed. During policy implementation process 212, at least one action may be identified to manage integration of set of changes 200 into codebase 216 (e.g., by a management entity such as management system 102 shown in FIG. 1). Identifying the at least one action may include comparing a quantity and/or other information included as part of result 210 to policy 214. Policy 214 may include a policy, schema, and/or other type of rule set keyed to change magnitudes usable to determine actions to be performed based on change magnitudes for sets of changes. Policy 214 may be obtained from an SME, management entity of the software program, and/or any other entity that participates in managing integration of set of changes 200 into codebase 216.

For example, policy 214 may include a list of actions to be performed based on a value of change magnitude 204, such as: (i) obtaining a testing paradigm (e.g., principles, methodologies, practices, and/or other information regarding tests to be performed to reduce a likelihood of undesired impacts on the updated version of the software program) to be performed prior to integrating set of changes 200 into codebase 216, (ii) rejecting at least a portion of set of changes 200 to reduce a value of change magnitude 204, (iii) assigning, based on change magnitude 204, a user (e.g., of user devices 100 shown in FIG. 1) to review set of changes 200 prior to integrating set of changes 200 into codebase 216, and/or (iv) other actions.

Policy implementation process 212 may also include performing the at least one action to obtain the updated version of the software program to continue provision of the computer-implemented services. For example, if result 210 indicates change magnitude 204 meets change magnitude criteria 208 (e.g., integrating set of changes 200 into codebase 216 has an acceptable risk of undesired impacts on the updated version of the software program), the at least one action identified from policy 214 may include integrating set of changes 200 into codebase 216. By performing the at least one action, set of changes 200 may be integrated into codebase 216, and the updated version of the software program may be obtained. The updated version of the software program may then be used as part of providing the computer-implemented services.

Returning to the above example, a change magnitude of 85 may be obtained for a set of changes based on a scale of 0-100, which may exceed a threshold value of 50 included in the change magnitude criteria (e.g., the set of changes may not meet the change magnitude criteria). Based on a policy for integrating sets of changes into codebases keyed to change magnitudes and the change magnitude of 85, it may be determined that at least a portion of the set of changes is to be rejected to reduce the change magnitude. For example, a portion of the set of changes may be removed from the set of changes, which may result in the change magnitude being reduced to 45. Consequently, the set of changes may meet the change magnitude criteria, and the set of changes may be integrated into the codebase to obtain the updated version of the software program.

Turning to FIG. 2B, a second data flow diagram in accordance with an embodiment is shown. The second data flow diagram may illustrate data used in and data processing performed, at least in part, in performing an analysis process to obtain a change magnitude (e.g., change magnitude 204) for a set of changes (e.g., set of changes 200). FIG. 2B may be an expansion of set of changes analysis process 202 shown in FIG. 2A.

Performing the analysis process to obtain change magnitude 204 may include (i) obtaining, using set of changes 200 and codebase 216, criticality value 222 for set of changes 200, (ii) obtaining, using set of changes 200 and codebase 216, similarity value 226 for set of changes 200, (iii) obtaining, using at least criticality value 222 and/or similarity value 226, change magnitude 204, and/or (iv) performing other tasks to obtain change magnitude 204.

To obtain criticality value 222, criticality analysis process 220 may be performed. During criticality analysis process 220, a degree of impact of integrating set of changes 200 into codebase 216 may be evaluated. The degree of impact may be based on a number of application programming interfaces (APIs) impacted by set of changes 200.

To evaluate the degree of impact of integrating set of changes 200 into codebase 216, codebase 216 may be used to determine the number of APIs (e.g., of an API call chain) that would be impacted by integrating set of changes 200 into codebase 216. Determining the number of APIs that would be impacted may include: (i) identifying API calls within codebase 216 that would be impacted by set of changes 200, (ii) analyzing software dependencies to identify any external APIs that would be impacted by set of changes 200, (iii) analyzing API documentation used by the software program to identify APIs likely to be impacted by set of changes 200, and/or (iv) other methods. For example, the software program that is to be modified using set of changes 200 may impact an external API, which may impact an API call chain (e.g., originating from the external API). The degree of impact may be obtained based on a number of APIs in the API call chain associated with the external API impacted by set of changes 200. The degree of impact may include a value assigned based on any scale and/or rubric usable to indicate degrees of impact (e.g., a numerical scale, a letter scale, other types of scales).

Based on the degree of impact, criticality value 222 may be assigned to set of changes 200. For example, criticality value 222 may be assigned based on a schema, rule set, table, and/or other type data structure usable to assign criticality values to sets of changes based on degrees of impact. For example, criticality value 222 may include a value from 1-10, where a higher value indicates a larger number of APIs would be impacted by set of changes 200, and a lower value indicates fewer APIs would be impacted by set of changes 200.

To obtain similarity value 226, similarity analysis process 224 may be performed. During similarity analysis process 224, set of changes 200 and a trained machine learning model (e.g., a large language model (LLM) and/or other type of artificial intelligence model) may be used to obtain: (i) a first summary of set of changes 200, and (ii) a second summary of at least a portion of the source code that would be impacted by integrating set of changes 200 into codebase 216.

The first summary may include a description of the functionality, purpose, and/or other information regarding set of changes 200. The first summary may represent the at least the portion of the source code after integration of set of changes 200 into codebase 216. For example, the first summary may include human readable text generated by an LLM using set of changes 200 as ingest for the LLM.

The second summary may include a description of the functionality, purpose, and/or other information regarding the at least the portion of the source code. The second summary may represent the at least the portion of the source code prior to the integration of set of changes 200 into codebase 216. Obtaining the second summary may include methods similar to obtaining the first summary. For example, an LLM may be used to obtain the second summary, which may include human readable text generated using the at least the portion of the source code that would be impacted by set of changes 200 from codebase 216 as ingest for the LLM.

The first summary and the second summary may be compared to obtain a difference. Comparing the first summary and the second summary may include: (i) obtaining a first embedding (e.g., a numeric vector) for the first summary and a second embedding for the second summary (e.g., using an algorithm and/or other type of software program for converting a textual summary into a representative numeric vector), (ii) comparing the first embedding and the second embedding based on any method of comparing similarity of two embeddings (e.g., cosine similarity) to obtain a difference, and/or (iii) assigning similarity value 226 to set of changes 200 based on the difference. Similarity value 226 may include a value assigned based on any scale and/or rubric usable to indicate a degree of similarity between the source code before and after integration of set of changes 200 into codebase 216. By comparing the first embedding and the second embedding, changes to the functionality and/or meaning of the source code, rather than changes to size/length of the source code, may be evaluated.

While described with respect to obtaining similarity value 226 using embeddings of textual summaries, it will be appreciated that any other method for assessing similarity may be used without departing from embodiments disclosed herein. For example, similarity value 226 may be obtained by feeding the first summary and the second summary into an LLM, prompting the LLM to compare the first summary and the second summary, and obtaining the difference and/or similarity value 226 as output from the LLM.

Criticality value 222 and similarity value 226 may be used to perform change magnitude calculation process 228. During change magnitude calculation process 228, change magnitude 204 may be calculated based on criticality value 222 and similarity value 226. For example, change magnitude 204 may be calculated by obtaining a combined and/or calculated value. The combined and/or calculated value may include, for example, a weighted sum of criticality value 222 and similarity value 226. Weights applied to criticality value 222 and similarity value 226 may be determined by an SME, a management entity, and/or any other entity that participates in managing integration of sets of changes into codebases (e.g., management system 102 shown in FIG. 1).

It will be appreciated that change magnitude 204 may be obtained, evaluated, and/or calculated using any other method, algorithm, and/or calculation without departing from embodiments disclosed herein.

Turning to FIG. 2C, a third data flow diagram in accordance with an embodiment is shown. The third data flow diagram may illustrate data used in and data processing performed, at least in part, in performing a code testing process for a set of changes to a codebase for a portion of software and evaluating outputs of the code testing process.

To perform the code testing process, testing process 232 may be performed using at least updated software instance 230. Updated software instance 230 may include a copy of the codebase (e.g., codebase 216) following integration of the set of changes (e.g., set of changes 200). Updated software instance 230, therefore, may represent a version of the software that may be deployed for use by downstream consumers (e.g., customers) if set of changes 200 is approved for use in updating the software.

During testing process 232, a test suite may be utilized to perform any number of tests (e.g., unit tests, component tests, integration tests, end-to-end tests) on updated software instance 230. The tests may be utilized to determine whether updated software instance 230 meets expectations (e.g., satisfies requirements provided by a test oracle). The tests of testing process 232 may be performed via any methods (e.g., manual testing, automated testing) and may utilize any testing techniques (e.g., black-box testing, white-box testing) without departing from embodiments disclosed herein.

Code testing result 234 and level of coverage 236 may be obtained as a result of testing process 232. Code testing result 234 may indicate whether the software updated based on the integrated codebase (e.g., updated software instance 230) operates in an acceptable manner. For example, code testing result 234 may include a “yes” or “no” answer regarding whether updated software instance 230 meets the requirements indicated by the test oracle (e.g., whether functionalities of the software operate as expected). Code testing result 234 may include any additional information related to tests performed during testing process 232 (e.g., metadata related to each test) without departing from embodiments disclosed herein.

Level of coverage 236 may include an indication of how many functionalities of updated software instance 230 were tested during testing process 232. Level of coverage 236 may include: (i) an overall percentage of functionalities tested, (ii) a list of the functionalities tested, (iii) a list of functionalities not tested, and/or (iv) other information related to the functionalities of updated software instance 230. For example, level of coverage 236 may indicate that 56% of the functionalities of updated software instance 230 were tested during testing process 232. The functionalities indicated by level of coverage 236 may include: (i) functions (e.g., subroutines) called during testing process 232, (ii) statements of updated software instance 230 executed during testing process 232, (iii) conditions evaluated for Boolean sub-expressions of updated software instance 230, (iv) APIs called during testing process 232, and/or (v) other types of functionalities.

Code testing result 234 and level of coverage 236 may be evaluated to determine whether the set of changes (e.g., set of changes 200) are to be approved for use in updating the codebase. For example, set of changes 200 may be rejected for use in updating the codebase if code testing result 234 indicates that updated software instance 230 did not satisfy all requirements for testing process 232. In addition, level of coverage 236 may be compared to level of coverage threshold 240 to determine whether level of coverage 236 is considered sufficient.

To obtain level of coverage threshold 240, threshold obtaining process 238 may be performed using change magnitude 204 (e.g., described in FIGS. 2A-2B). During threshold obtaining process 238, a quantity (e.g., quantification) of change magnitude 204 may be used to identify a level of coverage threshold keyed to the quantity. For example, threshold obtaining process 238 may include obtaining a code coverage policy, initiating an automated process including executing a script to generate level of coverage threshold 240, and/or other methods.

Levels of coverage may be keyed to change magnitudes and threshold obtaining process 238 may scale level of coverage thresholds with change magnitudes. For example, a code coverage policy may include a list of level of coverage thresholds (e.g., minimum of 40% coverage, minimum of 50% coverage, minimum of 60% coverage) and each level of coverage threshold may be keyed to a range of change magnitudes.

The change magnitude may, for example, be represented as a numerical quantity between 0-100. Threshold obtaining process 238 may utilize bucketized ranges that associate different change magnitudes with different level of coverage thresholds. A first bucketized range of the change magnitude (e.g., between 0-50) may be keyed to a minimum coverage (e.g., a level of coverage threshold) of 40%. A second bucketized range of the change magnitude (e.g., between 50-80) may be keyed to a minimum coverage of 50%. A third bucketized range of the change magnitude (e.g., between 80-100) may be keyed to a minimum coverage of 80%.

By scaling the level of coverage threshold with the change magnitude (e.g., a higher change magnitude may be keyed to a level of coverage threshold with more extensive testing requirements than a lower change magnitude), sets of changes that may have larger impacts on the codebase after integration may be subject to test suites that cover more functionalities of the software.

Policies, functions, and/or other rule sets may be used to select level of coverage threshold 240 using change magnitude 204 via any other methods and using other types of data (e.g., other than percentage coverage and numerical representations of change magnitude) without departing from embodiments disclosed herein.

Therefore, level of coverage threshold 240 may indicate a minimum level of testing of functionalities of the software (e.g., updated software instance 230) that must be met for the set of changes to be approved for use in updating the software. To determine whether level of coverage 236 meets level of coverage threshold 240, comparison process 242 may be performed. During comparison process 242, a quantity of level of coverage 236 (e.g., a percent coverage such as 56%) may be compared to a corresponding quantity of level of coverage threshold 240 (e.g., 60%).

In this example, level of coverage 236 may not meet level of coverage threshold 240 thereby indicating that the test suite used to perform testing process 232 was insufficient given change magnitude 204 for set of changes 200.

Level of coverage 236 not meeting level of coverage threshold 240 may indicate that integrating set of changes 200 into codebase 216 may have an unacceptable risk of undesired impacts on instances of the software obtained using the integrated codebase. Level of coverage 236 meeting level of coverage threshold 240 (e.g., if level of coverage 236 was at least 60% in the above example), therefore, may indicate that integrating set of changes 200 into codebase 216 may have an acceptable risk of the undesired impacts.

Comparison result 244 may be obtained as a result of comparison process 242. Comparison result 244 may include an indication of whether level of coverage 236 meets level of coverage threshold 240 (e.g., may include a “yes” or “no” response, may include human-interpretable text such as “pass” or “fail). If comparison result 244 indicates that level of coverage 236 meets level of coverage threshold 240, set of changes 200 may be integrated into codebase 216 to obtain an updated codebase and the software updated based on the updated codebase may be deployed (e.g., to downstream consumers) to facilitate provisioning of desired computer-implemented services.

If comparison result 244 indicates that level of coverage 236 does not meet level of coverage threshold 240, set of changes 200 may be rejected for integration into codebase 216.

Thus, by implementing the processes illustrated in FIGS. 2A-2C, a system in accordance with embodiments disclosed herein may be used to manage integration of sets of changes to source code into codebases based on change magnitudes for the sets of changes and level of coverage thresholds corresponding to the change magnitudes. The change magnitudes may be based on criticality and similarity values for the sets of changes. Consequently, a likelihood of introducing undesired impacts to the codebase may be reduced, and computer-implemented services may be provided as desired to downstream consumers.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to provide computer-implemented services using a data processing system. FIGS. 3A-3C illustrate methods that may be performed by the components of the system of FIG. 1. In the diagrams discussed below and shown in FIGS. 3A-3C, any of the operations may be repeated, performed in different orders, and/or performed in parallel with or in a partially overlapping in time manner with other operations.

Turning to FIG. 3A, a first flow diagram illustrating a method for providing computer-implemented services using a data processing system in accordance with an embodiment is shown. The method may be performed, for example, by any of the components of the system of FIG. 1, and/or any other entity without departing from embodiments disclosed herein.

At operation 300, a set of changes for a codebase may be obtained, the codebase including source code for a software program, and the set of changes including potential changes to the source code usable to obtain an updated version of the software program. Obtaining the set of changes may include: (i) reading the set of changes from storage, (ii) receiving the set of changes from another entity, (iii) generating the set of changes, and/or (iv) other methods.

Generating the set of changes may include: (i) identifying a modification that is to be made to at least a portion of the source code (e.g., to add functionalities to the software program, to improve security features, to fix errors in the source code), (ii) writing code that is to replace and/or be added to the source code to make the identified modification, (iii) packaging the code and/or metadata (e.g., including a description of the code, an identifier for a user who wrote the code, a date the code was written) to obtain the set of changes, and/or (iv) other methods.

At operation 302, an analysis process may be performed using the set of changes to obtain a change magnitude for the set of changes, the change magnitude indicating a level of change to the source code should the set of changes be integrated into the codebase. Performing the analysis process may include: (i) obtaining, using the set of changes and the codebase, a criticality value for the set of changes, (ii) obtaining, using the set of changes and the codebase, a similarity value for the set of changes, (iii) obtaining, using at least the criticality value and the similarity value, the change magnitude, (iv) providing the set of changes to another entity and receiving the change magnitude in response, and/or (v) other methods. Refer to the description of FIG. 3B for additional details regarding performing the analysis process.

At operation 304, a determination may be made, based on the change magnitude, regarding whether the change magnitude meets change magnitude criteria. Making the determination may include: (i) obtaining the change magnitude criteria, the change magnitude criteria including a threshold value for the change magnitude (e.g., receiving the change magnitude criteria from another entity, reading the change magnitude criteria from storage, generating the change magnitude criteria), (ii) comparing the change magnitude to the change magnitude criteria to obtain a result, (iii) providing the change magnitude to another entity and receiving an indication regarding whether the change magnitude meets the change magnitude criteria in response, and/or (iv) other methods.

Comparing the change magnitude to the change magnitude criteria may include methods similar to those described with respect to criteria comparison process 206 shown in FIG. 2A. For example, comparing the change magnitude to the change magnitude criteria may include: (i) comparing a quantity of the change magnitude to a quantity included in the change magnitude criteria (e.g., the threshold value and/or any other value) to obtain the result indicating whether the change magnitude meets the change magnitude criteria, (ii) comparing the quantity of the change magnitude to the quantity included in the change magnitude criteria to obtain other values, such as a difference between the change magnitude and the threshold value, and/or (iii) other methods.

At operation 306, at least one action may be identified to manage integration of the set of changes into the codebase based on the determination. Identifying the at least one action may include: (i) identifying, based on the change magnitude and a policy keyed to change magnitudes, the at least one action, (ii) providing the change magnitude and/or any other quantities to another entity and receiving the at least one action in response, and/or (iii) other methods.

Identifying the at least one action based on the change magnitude and a policy keyed to change magnitudes may include: (i) obtaining the policy (e.g., reading the policy from storage, receiving the policy from another entity, generating the policy), (ii) performing a search using the policy and the change magnitude as a key for the search to identify the at least one action, (iii) providing the change magnitude to another entity responsible for identifying the at least one action using the policy and receiving the at least one action in response, and/or (iv) other methods.

At operation 308, the at least one action may be performed to obtain the updated version of the software program to continue provision of the computer-implemented services. Performing the at least one action may include: (i) obtaining a testing paradigm to be performed prior to integrating the set of changes into the codebase (e.g., reading the testing paradigm from storage, receiving the testing paradigm from another entity, generating the testing paradigm), (ii) rejecting at least a portion of the set of changes to reduce the change magnitude (e.g., identifying the at least the portion of the set of changes to be rejected, removing the at least the portion of the set of changes from the set of changes, providing instructions to a user and/or other entity indicating that the at least the portion of the set of changes is to be removed from the set of changes), (iii) assigning, based on the change magnitude, a user to review the set of changes prior to integrating the set of changes into the codebase (e.g., identifying the user based on user skill level, experience, area of expertise, and/or other user characteristics, providing instructions to the user indicating that the user is to review the set of changes), (iv) integrating the set of changes into the codebase to obtain the updated version of the software program, (v) using the software program to facilitate provision of the computer-implemented services, and/or (vi) other methods.

The method may end following operation 308.

Turning to FIG. 3B, a second flow diagram illustrating a method for providing computer-implemented services using a data processing system in accordance with an embodiment is shown. The method may be performed, for example, by any of the components of the system of FIG. 1, and/or any other entity without departing from embodiments disclosed herein. The operations described in FIG. 3B may be an expansion of operation 302 shown in FIG. 3A.

At operation 320, a criticality value for the set of changes may be obtained using the set of changes and the codebase. Obtaining the criticality value may include: (i) evaluating a degree of impact of integrating the set of changes into the codebase, the degree of impact being based on a number of APIs impacted by the set of changes, (ii) assigning, based on the degree of impact, the criticality value, (iii) receiving the criticality value from another entity, (iv) reading the criticality value from storage, and/or (v) other methods.

Evaluating the degree of impact of integrating the set of changes into the codebase may include: (i) obtaining the number of APIs impacted by the set of changes, (ii) obtaining, based on the number of APIs, the degree of impact, (iii) receiving the degree of impact from another entity, and/or (iv) other methods.

Obtaining the number of APIs impacted by the set of changes may include: (i) identifying API calls within the codebase that would be impacted by the set of changes, (ii) analyzing software dependencies to identify any external APIs that would be impacted by the set of changes, (iii) analyzing API documentation used by the software program to identify APIs likely to be impacted by the set of changes, (iv) reading the number of APIs from storage, (v) receiving the number of APIs from another entity, and/or (vi) other methods.

Obtaining the degree of impact based on the number of APIs may include: (i) assigning the degree of impact based on the number of APIs (e.g., if the number of APIs is 20, the degree of impact may be 20), (ii) identifying the degree of impact using a schema, rule set, table, and/or other data structure usable to obtain degrees of impact based on the number of APIs, (iii) providing the number of APIs to another entity and receiving the degree of impact in response, and/or (iv) other methods.

Assigning the criticality value based on the degree of impact may include: (i) searching a schema, rule set, table, and/or other data structure using the degree of impact as a key for the search to identify the criticality value, (ii) providing the degree of impact to another entity and receiving the criticality value in response, and/or (iii) other methods.

At operation 322, a similarity value for the set of changes may be obtained using the set of changes and the codebase. Obtaining the similarity value may include: (i) obtaining, using the set of changes and a trained machine learning model, a first summary of the set of changes and a second summary of at least a portion of the source code that would be impacted by integrating the set of changes into the codebase, (ii) comparing the first summary and the second summary to obtain a difference, (iii) assigning, based on the difference, the similarity value, (iv) receiving the similarity value from another entity, (v) reading the similarity value from storage, and/or (vi) other methods.

Obtaining the first summary of the set of changes and the second summary of the at least the portion of the source code may include: (i) feeding the set of changes and the at least the portion of the source code into the trained machine learning model (e.g., an LLM) as ingest, (ii) prompting the trained machine learning model to summarize the set of changes and the at least the portion of the source code, (iii) obtaining the first summary and the second summary as output from the trained machine learning model, (iv) providing the set of changes and/or the at least the portion of the source code to another entity (e.g., that hosts and/or operates the trained machine learning model) and receiving the first summary and/or the second summary in response, and/or (v) other methods.

Comparing the first summary and the second summary to obtain the difference may include: (i) obtaining a first embedding (e.g., a numeric vector) for the first summary and a second embedding for the second summary (e.g., using an algorithm and/or other type of software program for converting a textual summary into a representative numeric vector), (ii) comparing the first embedding and the second embedding based on any method of comparing similarity of two embeddings (e.g., cosine similarity) to obtain the difference, (iii) feeding the first summary and the second summary to an LLM as ingest, (iv) prompting the LLM to compare the first summary and the second summary, (v) obtaining the difference as output from the LLM, (vi) providing the first summary and the second summary to another entity responsible for comparing the first summary and the second summary and receiving the difference in response, and/or (vii) other methods.

Assigning the similarity value based on the difference may include: (i) searching a schema, rule set, table, and/or other data structure using the difference as a key for the search to identify the similarity value, (ii) providing the difference to another entity and receiving the similarity value in response, and/or (iii) other methods.

At operation 324, the change magnitude may be obtained using at least the criticality value and the similarity value. Obtaining the change magnitude may include: (i) calculating the change magnitude using the criticality value and the similarity value, (ii) providing the criticality value and the similarity value to another entity and receiving the change magnitude in response, and/or (iii) other methods.

Calculating the change magnitude may include: (i) obtaining a weighted sum of the criticality value and the similarity value and using the weighted sum as the change magnitude, (ii) using any other algorithm and/or calculation to obtain the change magnitude using the criticality value and the similarity value, and/or (iii) other methods.

The method may end following operation 324.

Turning to FIG. 3C, a third flow diagram illustrating a method for providing computer-implemented services using a data processing system in accordance with an embodiment is shown. The method may be performed, for example, by any of the components of the system of FIG. 1, and/or any other entity without departing from embodiments disclosed herein. The operations described in FIG. 3C may be performed as part of determining whether to integrate a set of changes to a codebase for a portion of software.

At operation 330, an identification may be made that a code testing process is to be performed for a set of changes for a codebase for a portion of software. Making the identification may include: (i) receiving a notification from another entity (e.g., receiving a message over a communication system, receiving an alert through an API from another data processing system) that the set of changes is ready to be tested, (ii) obtaining an updated instance of the software based on the integrated codebase (e.g., generating the updated instance of the software, receiving the updated instance of the software from another entity, reading the updated instance of the software from storage), and/or (iii) other methods.

In response to the identification, operations 332-344 may be performed. Operations 332-344 are represented in FIG. 3C grouped by a dotted outline to indicate that operations 332-344 are performed based on operation 330.

At operation 332, a change magnitude may be obtained based on the set of changes. The change magnitude may indicate a level of change to operation of the software should the set of changes be integrated into the codebase and the software updated based on the integrated codebase. Obtaining the change magnitude may include: (i) reading the change magnitude from storage, (ii) receiving the change magnitude from another entity, (iii) performing an analysis process to generate the change magnitude (e.g., refer to operation 302 in FIG. 3A and the expansion of operation 302 in FIG. 3B), and/or (iv) other methods.

At operation 334, a level of coverage threshold may be obtained for the code testing process based on the change magnitude. Obtaining the level of coverage threshold may include: (i) reading the level of coverage threshold from storage (e.g., searching a policy or other data structure including level of coverage thresholds keyed to change magnitudes), (ii) obtaining the level of coverage threshold from another entity (e.g., providing the change magnitude to the entity and receiving the level of coverage threshold in response to providing the change magnitude), (iii) generating the level of coverage threshold (e.g., using a script that retrieves and/or generates level of coverage thresholds keyed to change magnitudes), and/or (iv) other methods.

At operation 336, a code testing process may be performed on the software updated based on the integrated codebase to obtain a code testing result and a level of coverage achieved during the code testing process. Performing the code testing process may include: (i) obtaining an updated instance of the software (e.g., based on the codebase and the set of changes), (ii) obtaining a test suite for the updated instance of the software (e.g., reading the test suite from storage, receiving the test suite from another entity, generating the test suite), (iii) executing the test suite to perform any number of tests for the updated instance of the software, (iv) providing the test suite to another entity responsible for executing at least a portion of the test suite, and/or (v) other methods. Refer to FIG. 2C for additional details regarding the code testing process. The code testing result and the level of coverage may be obtained as a result of completing the code testing process.

At operation 338, it may be determined whether the level of coverage meets the level of coverage threshold. Determining whether the level of coverage meets the level of coverage threshold may include: (i) obtaining a representation of the level of coverage (e.g., a percent, a number on a scale, an enumerated list of tests performed), (ii) obtaining a corresponding representation of the level of coverage threshold (e.g., a minimum percent, a minimum number on a scale, an enumerated lists of tests expected to be performed), (iii) comparing the representation of the level of coverage to the representation of the level of coverage threshold, and/or (iv) other methods.

If the level of coverage meets the level of coverage threshold (e.g., the level of coverage is considered acceptable), the method may proceed to operation 340.

At operation 340, the set of changes may be integrated into the codebase to obtain an updated codebase. Integrating the set of changes into the codebase may include: (i) modifying the codebase (e.g., adding portions of code, removing portions of code, modifying portions of code) to generate the updated codebase, (ii) providing the set of changes to another entity responsible for generating the updated codebase, and/or (iii) other methods.

At operation 342, the software may be deployed based on the updated codebase to facilitate provisioning of desired computer-implemented services. Deploying the software may include: (i) identifying a target for deployment (e.g., a target location such as a server and/or a data processing system, a target downstream consumer), (ii) making an instance of the software available at the target (e.g., saving an instance of the integrated codebase in a particular location on a server, providing an instance of the integrated codebase to a downstream consumer), and/or (iii) other methods.

The method may end following operation 342.

Returning to operation 338, the method may proceed to operation 344 if the level of coverage does not meet the level of coverage threshold.

At operation 344, the set of changes may be rejected for integration into the codebase. Rejecting the set of changes may include: (i) not modifying the codebase, (ii) providing a notification (e.g., to an SME) that the set of changes were not integrated into the codebase, (iii) initiating one or more actions to modify the set of changes and/or the test suite to increase a likelihood of updating the software, and/or (iv) other methods.

The method may end following operation 344.

Thus, as illustrated above, embodiments disclosed herein may provide systems and methods usable to manage integration of sets of changes into codebases for software programs in a manner that reduces a likelihood of negatively impacting the software programs. Consequently, computer-implemented services provided using the software programs may be provided as desired by downstream consumers of the computer-implemented services.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using a data processing system, the method comprising:
making an identification that a code testing process is to be performed for a set of changes for a codebase for a portion of software;
based on the identification:
obtaining, based on the set of changes, a change magnitude, the change magnitude indicating a level of change to operation of the software should the set of changes be integrated into the codebase and the software updated based on the integrated codebase;
obtaining, based on the change magnitude, a level of coverage threshold for the code testing process, the level of coverage threshold indicating a minimum level of testing of functionalities of the software;
performing the code testing process on the software updated based on the integrated codebase to obtain a code testing result and a level of coverage achieved during the code testing process, the code testing result indicating whether the software updated based on the integrated codebase operates in an acceptable manner;
in a first instance of the code testing process in which the level of coverage meets the level of coverage threshold:
integrating of the set of changes into the codebase to obtain an updated codebase; and
deploying the software updated based on the updated codebase to facilitate provisioning of desired computer-implemented services.

2. The method of claim 1, further comprising:
in a second instance of the code testing process in which the level of coverage does not meet the level of coverage threshold:
rejecting the set of changes for integration into the codebase.

3. The method of claim 1, wherein the codebase comprises source code for the portion of software and the set of changes comprises potential changes to at least a portion of the source code usable to obtain an updated version of the software.

4. The method of claim 1, wherein the level of coverage threshold is obtained using a process that is keyed to the change magnitude, and the process scales the level of coverage threshold with the change magnitude.

5. The method of claim 4, wherein the process uses bucketized ranges that associate different change magnitudes with different level of coverage thresholds.

6. The method of claim 1, wherein a higher change magnitude indicates integrating the set of changes into the codebase has an increased risk of undesired impacts on instances of the software obtained from the integrated codebase.

7. The method of claim 6, wherein a higher change magnitude is keyed to a level of coverage threshold associated with more extensive testing requirements than a lower change magnitude.

8. The method of claim 6, wherein the level of coverage meeting the level of coverage threshold indicates integrating the set of changes into the codebase has an acceptable risk of the undesired impacts on the instances of the software obtained from the integrated codebase.

9. The method of claim 1, wherein the change magnitude is a weighted sum of a criticality value and a similarity value.

10. The method of claim 9, wherein the criticality value indicates a degree of impact of integrating the set of changes into the codebase, the degree of impact being based on a number of application programming interfaces (APIs) impacted by the set of changes.

11. The method of claim 9, wherein the similarity value is based on a difference between a first summary of the set of changes and a second summary of the at least a portion of source code for the portion of software.

12. A non-transitory machine-readable medium having instructions stored therein, which when executed by a processor, cause the processor to perform operations for providing computer-implemented services using a data processing system, the operations comprising:
making an identification that a code testing process is to be performed for a set of changes for a codebase for a portion of software;
based on the identification:
obtaining, based on the set of changes, a change magnitude, the change magnitude indicating a level of change to operation of the software should the set of changes be integrated into the codebase and the software updated based on the integrated codebase;
obtaining, based on the change magnitude, a level of coverage threshold for the code testing process, the level of coverage threshold indicating a minimum level of testing of functionalities of the software;
performing the code testing process on the software updated based on the integrated codebase to obtain a code testing result and a level of coverage achieved during the code testing process, the code testing result indicating whether the software updated based on the integrated codebase operates in an acceptable manner;
in a first instance of the code testing process in which the level of coverage meets the level of coverage threshold:
integrating of the set of changes into the codebase to obtain an updated codebase; and
deploying the software updated based on the updated codebase to facilitate provisioning of desired computer-implemented services.

13. The non-transitory machine-readable medium of claim 12, further comprising:
in a second instance of the code testing process in which the level of coverage does not meet the level of coverage threshold:
rejecting the set of changes for integration into the codebase.

14. The non-transitory machine-readable medium of claim 12, wherein the codebase comprises source code for the portion of software and the set of changes comprises potential changes to at least a portion of the source code usable to obtain an updated version of the software.

15. The non-transitory machine-readable medium of claim 12, wherein the level of coverage threshold is obtained using a process that is keyed to the change magnitude, and the process scales the level of coverage threshold with the change magnitude.

16. The non-transitory machine-readable medium of claim 15, wherein the process uses bucketized ranges that associate different change magnitudes with different level of coverage thresholds.

17. A data processing system, comprising:
a processor; and
a memory coupled to the processor to store instructions, which when executed by the processor, cause the processor to perform operations for providing computer-implemented services using a data processing system, the operations comprising:
making an identification that a code testing process is to be performed for a set of changes for a codebase for a portion of software;
based on the identification:
obtaining, based on the set of changes, a change magnitude, the change magnitude indicating a level of change to operation of the software should the set of changes be integrated into the codebase and the software updated based on the integrated codebase;
obtaining, based on the change magnitude, a level of coverage threshold for the code testing process, the level of coverage threshold indicating a minimum level of testing of functionalities of the software;
performing the code testing process on the software updated based on the integrated codebase to obtain a code testing result and a level of coverage achieved during the code testing process, the code testing result indicating whether the software updated based on the integrated codebase operates in an acceptable manner;
in a first instance of the code testing process in which the level of coverage meets the level of coverage threshold:
integrating of the set of changes into the codebase to obtain an updated codebase; and
deploying the software updated based on the updated codebase to facilitate provisioning of desired computer-implemented services.

18. The data processing system of claim 17, wherein the operations further comprise:
in a second instance of the code testing process in which the level of coverage does not meet the level of coverage threshold:
rejecting the set of changes for integration into the codebase.

19. The data processing system of claim 17, wherein the codebase comprises source code for the portion of software and the set of changes comprises potential changes to at least a portion of the source code usable to obtain an updated version of the software.

20. The data processing system of claim 17, wherein the level of coverage threshold is obtained using a process that is keyed to the change magnitude, and the process scales the level of coverage threshold with the change magnitude.
